(19) United States
(12) Patent Application Publication
(10) Pub. No.: US 2006/0100854 A1
(43) Pub. Date: May 11, 2006

(54) Computer generation of concept sequence correction rules

(75) Inventors: Celine Ance, Perros-Guirec (FR); Philippe Bretier, Trelevern (FR); Franck Panaget, Trebeurden (FR)

Correspondence Address: LOWE HAUPTMAN GILMAN AND BERNER, LLP, 1700 DIAGONAL ROAD, SUITE 300 /310, ALEXANDRIA, VA, 22314, US

(73) Assignee: FRANCE TELECOM, Paris (FR)

(21) Appl. No.: 11/246,547

(22) Filed: Oct. 11, 2005

(30) Foreign Application Priority Data
Oct. 12, 2004 (FR) 0410788

(51) Int. Cl. G06F 17/27

(52) U.S. Cl. 704/9

(57) ABSTRACT

A system generates rules for the correction of a concept sequence, a concept sequence coming from a text statement. A module determines from first text statements, a set of first concept sequences liable to be corrected and from second text statements, a set of second concept sequences deemed to be valid. A comparator compares the two sets of concept sequences thereby selecting first concept sequences different from second concept sequences. A generator analyzes the selected first concept sequences and estimates at least one characteristic for each first concept sequence analyzed. The generator generates at least one concept sequence correction rule as a function of said at least one estimated characteristic.

### BACKGROUND OF THE INVENTION

1-Field of the Invention

The present invention relates to a computer method of generating concept sequence correction rules. The field of the invention is that of interpreting statements in natural language, for example in the course of a service employing a dialog between a person and a machine or of functions for semantically analyzing a text or voice document.

2-Description of the Prior Art

Prior art systems for determining concept sequences generally operate in two phases, a first phase in which the concept sequences are determined and a second phase in which the concept sequences are validated, corrected or eliminated. To be more precise, in the second phase the concept sequences are corrected and then validated against knowledge specific to the linguistic domain of the concept sequences implemented through functions such as grouping concepts into more complex concepts, transforming concepts as a function of their collocation, and detecting a particular order of concepts in sequences denoting a particular sense.

Accordingly, prior art systems for determining concept sequences are confronted by ongoing enrichment with new functions that improve the process of concept sequence determination. However, prior art systems do not offer complete correction and validation of concept sequences, since some of them are never processed by these functions. Consequently, prior art systems evolve with difficulty and do not offer a complete solution for concept sequence determination.

### OBJECT OF THE INVENTION

An object of the invention is to remedy the drawbacks cited above through computer generation of concept sequence correction rules in order to produce a concept sequence correction system that lends itself to evolution.

### SUMMARY OF THE INVENTION

To achieve this object, a computer method of generating rules for the correction of concept sequence, a concept sequence coming from a text statement, is characterized in that it includes the following steps:

determining and storing from first text statements a set of first concept sequences liable to be corrected;

determining and storing a set of second concept sequences deemed to be valid from second text statements;

comparing the set of first concept sequences to the set of second concept sequences and selecting first concept sequences different from second concept sequences;

analyzing the selected first concept sequences and estimating at least one characteristic for each first concept sequence analyzed; and

generating and storing at least one concept sequence correction rule as a function of said at least one estimated characteristic.

The invention also concerns a computer system for generating rules for the correction of a concept sequence, a concept sequence coming from a text statement. The system is characterized in that it includes:

means for determining from first text statements and storing a set of first concept sequences liable to be corrected;

means for determining from second text statements and storing a set of second concept sequences deemed to be valid;

means for comparing the set of first concept sequences to the set of second concept sequences and selecting first concept sequences different from second concept sequences;

means for analyzing the selected first concept sequences and estimating at least one characteristic for each first concept sequence analyzed; and

means for generating and storing at least one concept sequence correction rule as a function of said at least one estimated characteristic.

### BRIEF DESCRIPTION OF THE DRAWINGS

Other features and advantages of the present invention will become more clearly apparent on reading the following description of several preferred embodiments of the invention, given by way of nonlimiting examples and with reference to the corresponding appended drawings, in which:

FIG. 1 is a schematic block diagram of a computer system for correcting concept sequences using the computer method of the invention for generating concept sequence correction rules; and

FIG. 2 is an algorithm of the computer method of the invention for generating concept sequence correction rules.

### DESCRIPTION OF THE PREFERRED EMBODIMENTS

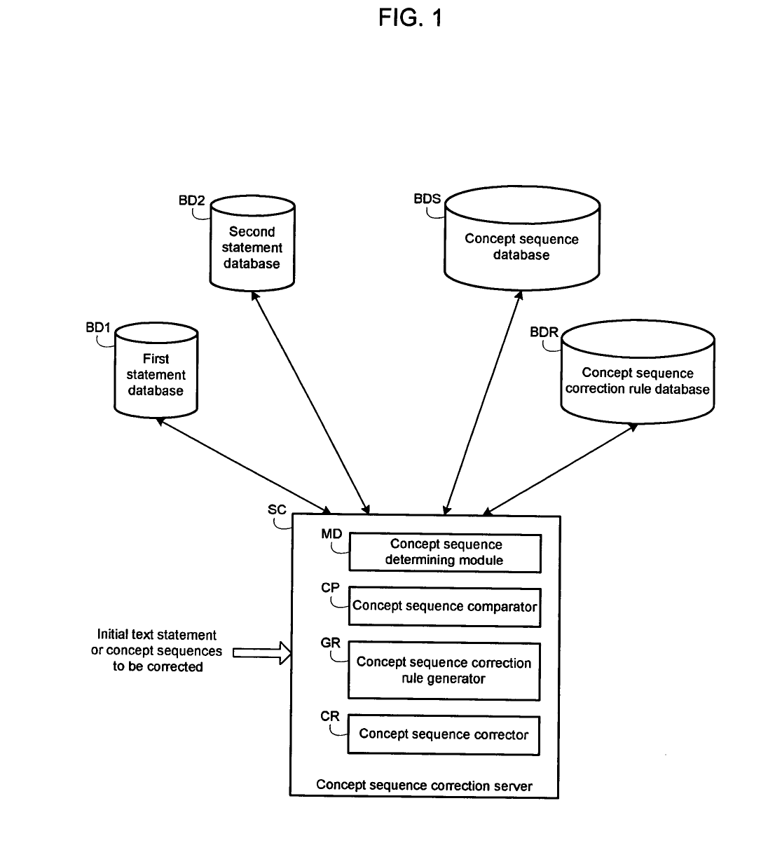

Referring to FIG. 1, the computer system for correcting concept sequences using the correction method of the invention primarily comprises a concept sequence correction server SC, a first statement database BD1, a second statement database BD2, a concept sequence database BDS, and a concept sequence correction rule database BDR.

The concept sequence correction server SC primarily comprises a module MD for determining concept sequences, a concept sequence comparator CP, a concept sequence correction rule generator GR, and a concept sequence corrector CR.

One variant of the system comprises databases containing data from at least two of the four databases BD1, BD2, BDS and BDR.

The database BDR can initially include concept sequence correction rules.

The databases are partly or fully incorporated in the correction server SC or in database servers that can be connected to the correction server SC via a telecommunication network.

In another variant, the concept sequence corrector GR is included in a server different from the correction server SC in order to separate concept sequence correction rule generation completely from concept sequence correction.

The correction server SC either receives an initial text statement or receives concept sequences directly. This initial text statement is established and transmitted by a voice recognition system processing voice signals of a voice service, for example. The concept sequences are established and transmitted by a language processing system, for example.

Concept sequences are determined from the initial text statement. These concept sequences derived from the initial statement or the concept sequences supplied directly are then corrected automatically in accordance with the invention. An initial statement represents an enquiry from a user in text form, for example. If the user request is in audio and/or video form, an initial text statement is extracted from the user enquiry, for example by a voice recognition engine.

A first text statement is a statement participating in the production of concept sequence correction rules and usable to determine concept sequences to be corrected. The first text statement is a transformed text statement resulting from automatic transformation of a user enquiry, for example. If the user enquiry is in audio form, for example, a voice recognition engine extracts the sound of the user enquiry in order to convert the sound into text. In another example, if the user enquiry is in the form of a short video sequence, sound is extracted from the video sequence for the voice recognition engine to determine the text from the extracted sound.

A second text statement participates in the production of concept sequence correction rules. Concept sequences are determined from the second text statement and are deemed to be valid, as opposed to the concept sequences to be corrected. The second statement is a transcribed text statement resulting from manual or pseudo-manual transformation of the user enquiry, for example. This transformation is effected by means of softwares for assisting with the transcription and annotation of audio signals, for example, which partially assists an administrator user (“transcriber”) by prompting him via a graphical interface to segment the audio signals, transcribe words contained in the audio signals, mark turns at speaking, i.e. changes of speaker, and annotate the audio signals in order to segment them thematically and acoustically. Functions of this kind are provided by the two software products “Transcriber” and “Praat”.

A concept is a text representation of the sense of a word or a group of words in a text statement, for example a first or second text statement. In the examples given hereinafter, concepts are represented in parentheses (concept) and concept sequences between square brackets [(concept1)(concept2)]. For example, the concepts of the following transformed or transcribed statement “I am looking for a hotel in Prague, er not in Budapest” are [(Sleep)(Place1)(Place2)]. The concepts of a statement may be determined from correspondences between an index of words or groups of words associated with concepts. The different combinations of successive concepts of a text statement are called “concept sequences”. Concept sequences for the preceding example are [(Sleep)(Place1)(Place2)] or [(Sleep)(Place1)] or [(Sleep)(Place2)], for example. A concept sequence may comprise only one concept.

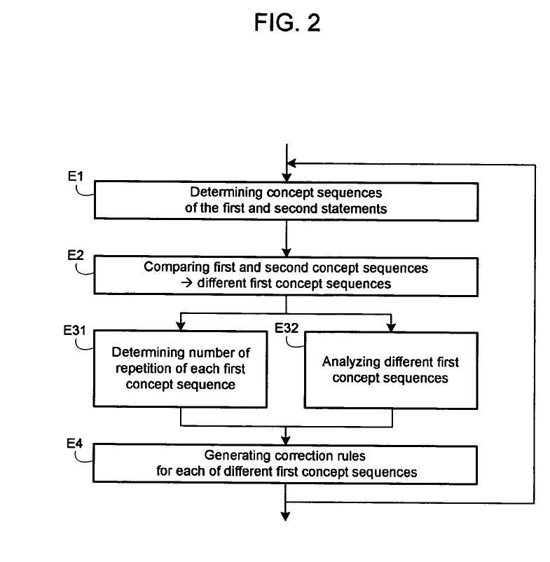

The method of the invention for generating correction rules primarily comprises the steps E1 to E4 shown in FIG. 2.

Those steps are repeated regularly to process first and second text statements recently stored in the databases BD1 and BD2. The objective of subsequent steps is to deduce correction rules as a function of the result of comparing a set of first concept sequences coming from first statements and a set of second concept sequences coming from second statements and deemed to be valid.

For example, during a voice service for finding a restaurant employing a dialog between a user and a machine, the first statements result from a voice recognition engine processing the user's voice enquiry and are stored regularly in the first statement database BD1. In this example, the second statements are transcriptions of the first statements. A transcription is a manual transformation of a text or voice statement assisted by transcription software. The concepts deemed to be valid are then determined, in the present example, as a function of the second statements, as the second statements have been checked by a human operator.

In the step E1, the concept sequence determining module MD determines first and second concept sequences respectively as a function of first and second statements respectively stored in the first and second predetermined statement databases BD1 and BD2. The first and second concept sequences determined in this way are stored in the concept sequence database BDS. The concepts are generally determined by transforming a sequence of words into a sequence of concepts as a function of conversion rules. In one variant, concept determination relies on the correspondences between word sequences and concept sequences.

Alternatively, the method of the invention accepts all concept sequences determined or all concept sequence determining modules, i.e. all the means employed to determine concept sequences of a text statement.

For example, the first statement is obtained by a voice recognition engine processing a user enquiry in English:

“I'd like to eat something near bye Champs Elysées”.

The first concept sequence determined from this first statement is:

[(Restaurant)(By)(End_of session)(Champs_Elysées)].

In this example, the second statement derived by transcribing the first statement is “I'd like to eat something by Champs Elysées” and the concept sequence determined is:

[(Restaurant)(By)(Champs_Elysées)].

In another example, the first statement is “yes er no thank you an Italian” and the first concept sequence determined is [(Yes)(No)(Thank_you)(Italian)]. The second statement is the following transcription of the first statement: “no thank you an Italian” and the concept sequence determined is [(No)(Thank_you)(Italian)].

In the step E2, the comparator CP compares each first concept sequence to the second concept sequences that have been determined to select first concept sequences different from second concept sequences and stores these different first concept sequences in the concept sequence database BDS. The first concept sequences being different from second concept sequences, the first concept sequences do not satisfy the correction rules initially stored in the correction rule database BDR.

Alternatively, the different first concept sequences are stored in the correction rules database BDR.

Alternatively, a first or second sequence may be a sub-sequence of the first sequence, respectively the second sequence. Consequently, the comparator determines all possible combinations of concept sequences from the concept sequences determined, without modifying the order of the concepts of the sequences determined, which makes the concept sequence comparison results more accurate. In the example where the first concept sequence determined is:

[(Restaurant)(By)(End_of_session)(Champs_Elysées)] and

the second concept sequence is:

[(Restaurant)(By)(Champs_Elysées)],

the comparator CP compares each of the following first concept sequences:

[(Restaurant)(By)(End_of_session)(Champs_Elysées)],

[(Restaurant)(By)(End_of_session)],

[(By)(End_of_session)(Champs_Elysées)],

[(Restaurant)(By)],

[(By)(End_of_session)],

[(End_of_session)(Champs_Elysées)]

and the following second sequences:

[(Restaurant)(By)(Champs_Elysées)],

[(By)(Champs_Elysées)],

[(Restaurant)(By)].

In this example, the first concept sequences different from second sequences are:

[(Restaurant)(By)(End_of_session)(Champs_Elysées)],

[(Restaurant)(By)(End_of_session)],

[(By)(End_of_session)(Champs_Elysées)],

[(By)(End_of_session)],

[(End_of_session)(Champs_Elysées)].

Alternatively, a second statement corresponds to a transcription of a first predetermined statement. The sequence comparison applies to the first concept sequence determined as a function of the first predetermined statement and the second concept sequence determined as a function of the second statement corresponding to the transcription.

After the step E2, the subsequent steps E31 and E32 are preferably executed either in parallel or successively with the step E31 preceding the step E32.

In the step E31, the concept rule generator GR determines a number of repetition of each different first concept sequence from the set of the first concept sequences. For example, the generator determines that the different first concept sequence [(By)(End_of_session)] is repeated 13 times in the set of first concept sequences determined.

In the step E32, the generator GR analyzes each of the different first concept sequences, generally by executing an analysis algorithm, in order to estimate characteristics of each different first sequence and to store them in the database BDS in association with the first sequence.

The characteristics of different first concept sequences are, for example, concepts that do not exist in the second sequences, the position of the concepts in each first sequence, a list of the number of repetitions of a concept in the first sequence, etc.

In the step E4, the generator GR generates at least one correction rule for each different first concept sequence depending on the estimated characteristics of the latter if the number of repetition of the different first concept sequence is above a predetermined threshold. The correction rules generated are stored in the concept sequence correction rule database BDR in association with an address of the different first concept sequence. For example, the predetermined threshold is 10 and the generator generates a correction rule only for the different first concept sequence for which the number of repetitions is greater than 10.

Rule generation is based on the preceding analysis of each first sequence. For example, for the first concept sequence:

[(By)(End_of_session)(Champs_Elysées)],

the generator GR estimates by way of characteristics the position of the (End_of_session) concept in this sequence and compares it to the positions of this concept in the second statement sequences. Starting from the postulate that the concept sequences of the second statements are valid, the generator deduces, for example, the following correction rule: “the (End_of_session) concept is placed only at the end of a sequence”.

Alternatively, the step E31 is eliminated and the generator GR generates a correction rule for each of the different first concept sequences.

Once the computer has determined a large number of rules, the correction server SC is ready to correct concept sequences.

The correction server receives an initial statement whereof the concept sequences must be determined and corrected. The corrector CR corrects the predetermined concept sequences on the basis of the initial statement as a function of the concept sequence correction rules generated. Correction consists in applying concept sequence correction rules. The corrected concept sequences obtained from the initial statement or the received concept sequences are subsequently subjected to linguistic processing, in particular semantic analysis.

For example, the initial statement is “I want ADSL on the Internet”. The module MD determines the corresponding concept sequence [(ADSL)(Internet)]. The corrector CR determines if a stored correction rule applies to at least one of the concepts of the sequence. In this example, only one correction rule is determined: “eliminate one of the two concepts”. The collocation of the concepts (ADSL) and (Internet) is of no use because of the redundant information. The concept sequence after correction is [(ADSL)].

In another example, the initial statement is “er yes sorry no I prefer a hotel”. The module MD determines the corresponding concept sequence:

[(Yes)(Sorry)(No)(Hotel)]

In this example, the correction rules to be applied are “eliminate polite formula” and “eliminate contradiction”. This is because the polite formula between two contradictory adverbs provides no pertinent information, and one of the adverbs must be eliminated. The concept sequence after correction is [(No)(Hotel)].

Alternatively, the correction server SC receives concept sequences to be corrected directly and the correction server therefore does not need to determine the concept sequences.

A further alternative is for the administrator of the server SC to create and add at least one predetermined concept sequence correction rule to the correction rules database BDR, to complete and refine concept sequence correction.

The invention is not limited to the embodiments described above and variants thereof.

The invention described here relates to a method and a system for generating concept sequence correction rules. According to a preferred implementation, the steps of the method are determined by the instructions of a program incorporated in the correction server SC for generating concept sequence correction rules, and the method of the invention is executed when that program is loaded into the correction server SC or any other computer whose operation is then controlled by the execution of the program.

As a consequence, the invention applies also to a computer program, in particular a computer program on or in an information medium, adapted to implement the invention. This program can use any programming language whatsoever and be in the form of source code, object code, or code intermediate between source code and object code such as in a partially compiled form, or in any other form whatsoever desirable to implement a method according to the invention.

The information medium may be any entity or device whatsoever capable of storing the program. For example, the medium may comprise a means of storage, such as a ROM, for example a CD ROM or a microelectronic circuit ROM or else a magnetic recording means, for example a floppy disk or a hard disk.

Moreover, the information medium may be a transmissible medium such as an electrical or optical signal, which may be routed via an electrical or optical cable, by radio or by other means. The program according to the invention may in particular be downloaded on an Internet type network.

Alternatively, the information medium may be an integrated circuit in which the program is incorporated, the circuit being adapted to execute or to be used in the execution of the method according to the invention.

What we claim is:

1. A method of generating rules for the correction of concept sequence, a concept sequence coming from a text statement, said method including the following steps:
determining and storing from first text statements a set of first concept sequences liable to be corrected;
determining and storing a set of second concept sequences deemed to be valid from second text statements;
comparing said set of first concept sequences to said set of second concept sequences and selecting first concept sequences different from second concept sequences;
analyzing the selected first concept sequences and estimating at least one characteristic for each first concept sequence analyzed; and
generating and storing at least one concept sequence correction rule as a function of said at least one estimated characteristic.

2. A method as claimed in claim 1, including al correction of the concept sequences of an initial statement as a function of the concept sequence correction rules generated.

3. A method as claimed in claim 1, wherein including a determination of the concept sequences of an initial statement, and a correction of the concept sequences of said initial statement as a function of the concept sequence correction rules generated.

4. A method as claimed in claim 1, wherein a second statement corresponds to a transcription of a first predetermined statement, and said step of comparing applies to the first concept sequence determined as a function of said first predetermined statement and the second concept sequence determined as a function of said second statement corresponding to said transcription.

5. A method as claimed in claim 1, including determination of a number of repetition of each different first concept sequence from said set of said first concept sequences so as to generate at least one correction rule for said different first concept sequence only if the number of repetition is above a predetermined threshold.

6. A method as claimed in claim 1, including addition of one predetermined concept sequence correction rule to the generated concept sequence correction rules.

7. A system for generating rules for the correction of a concept sequence, a concept sequence coming from a text statement, said system including:
means for determining from first text statements and storing a set of first concept sequences liable to be corrected;
means for determining from second text statements and storing a set of second concept sequences deemed to be valid;
means for comparing said set of first concept sequences to said set of second concept sequences and selecting first concept sequences different from second concept sequences;
means for analyzing the selected first concept sequences and estimating at least one characteristic for each first concept sequence analyzed; and
means for generating and storing at least one concept sequence correction rule as a function of said at least one estimated characteristic.

8. A system as claimed in claim 1, including means for correcting predetermined concept sequences as a function of the concept sequence correction rules generated.

9. A computer program on an information medium adapted to be implemented in a system for generating rules for the correction of concept sequence, a concept sequence coming from a text statement, said program including program instructions which, when said program is loaded and executed in said computing system, carry out the following steps:
determining and storing from first text statements a set of first concept sequences liable to be corrected;
determining and storing a set of second concept sequences deemed to be valid from second text statements;
comparing said set of first concept sequences to said set of second concept sequences and selecting first concept sequences different from second concept sequences;
analyzing the selected first concept sequences and estimating at least one characteristic for each first concept sequence analyzed; and
generating and storing at least one concept sequence correction rule as a function of said at least one estimated characteristic.
